(19) United States
(12) Patent Application Publication
(10) Pub. No.: US 2016/0007176 A1
(43) Pub. Date: Jan. 7, 2016

(54) EMERGENCY CALL HANDLING IN CELLULAR NETWORKS AFTER FAILED AUTHENTICATION

(71) Applicant: BROADCOM CORPORATION, Irvine, CA (US)

(72) Inventors: Matti Tapani MOISANEN, Oulu (FI); Markku Kalevi Vuontisjarvi, Oulu (FI); Sridhar Prakasam, Morganville, NJ (US)

(73) Assignee: BROADCOM CORPORATION, Irvine, CA (US)

(21) Appl. No.: 14/455,133

(22) Filed: Aug. 8, 2014

Related U.S. Application Data
(60) Provisional application No. 62/021,398, filed on Jul. 7, 2014.

(51) Int. Cl. H04W 4/22; H04W 12/06

(52) U.S. Cl. CPC H04W 4/22; H04W 12/06

(57) ABSTRACT

A mobile device may place an emergency call via a wireless cellular network. The mobile device receives an initiation of the emergency call and determines whether a first base station to which it is attempting to connect is authenticated. Authentication of the first base station is determined based on a state of an authentication timer of the mobile device. If authentication of the first base station fails, the mobile device establishes a connection to a second base station and places the emergency call via the connection with the second base station.

### CROSS REFERENCE TO RELATED APPLICATIONS

This application claims the benefit of priority under 35 U.S.C. 119(e) to provisional U.S. Patent Application No. 62/021,398, entitled “Emergency Call Handling in Cellular Networks After Failed Authentication” and filed Jul. 7, 2014, the contents of which are incorporated herein by reference.

### FIELD

Exemplary embodiments of the present disclosure relate to the handling of emergency calls by a mobile terminal connected to a wireless cellular network. More specifically, the exemplary embodiments relate to methods, systems and devices for handling emergency calls after an authentication failure between a mobile terminal and a base station of the wireless cellular network.

### BACKGROUND

Cell phones, tablet computers and other mobile devices are used for everything from placing phone calls, to accessing the Internet and streaming media. Because of the wide array of functions offered, these devices have become pervasive in modern-day society, increasing the likelihood that they will be used to summon help in the event of an emergency. An emergency call to, for example, police or fire rescue personnel must therefore be given priority within a wireless cellular network.

Because of their transient nature, moving from one wireless cell to another, mobile devices frequently establish and terminate communication connections with base stations of different cells. In order to ensure network security and integrity, a wireless cellular network periodically sends authentication requests to a mobile device to cause the mobile device to perform a mutual authentication process between itself and a base station of a cell in which it resides. If the mobile device is unable to authenticate the base station, it refuses further communication with the base station (bars the base station) and connects to another base station of another cell. Since cell coverage areas frequently overlap, a barred base station seldom results in a significant loss of services for the mobile device. The protocols and procedures for the authentication of a base station by a mobile device are defined in such standards as 3GPP, 3GPP LTE, 4G, 4G LTE and the like.

Conventional systems do not address how to handle an emergency call after an authentication failure between a mobile device and a base station. However, such calls must be handled in a well-defined manner to avoid possible interruption. Further limitations and disadvantages of conventional and traditional approaches will become apparent to one of ordinary skill in the art by a comparison of such systems with the present disclosure as set forth in the remainder of this application, its claims and drawings.

### SUMMARY

An apparatus, system and associated methodology for placing emergency calls via a mobile terminal and a cellular network after authentication failure between the mobile terminal and a base station of the wireless cellular network, as set forth more completely in the claims of this application.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a diagram of authentication between a mobile terminal (also referred to as user equipment) and a base station of a cell in a wireless cellular network according to exemplary aspects of the disclosure;

FIG. 2 is a diagram illustrating the establishment of a connection between the mobile terminal and the base station after successful authentication in accordance with exemplary aspects of the disclosure;

FIG. 3 is a diagram illustrating the barring of the base station upon authentication failure in accordance with exemplary aspects of the disclosure;

FIG. 4 is an algorithmic flowchart of the authentication process performed by the mobile terminal according to exemplary aspects of the disclosure;

FIG. 5 is an algorithmic flowchart of the handling of an emergency call by the mobile terminal during authentication of the base station in accordance with exemplary aspects of the disclosure;

FIG. 6 is an algorithmic flowchart of another process for handling an emergency call by the mobile terminal during authentication of the base station in accordance with exemplary aspects of the disclosure;

FIG. 7 is a an algorithmic flowchart of a further emergency call handling process performed by the mobile terminal during authentication of the base station according to exemplary aspects of the disclosure;

FIG. 8 is an algorithmic flowchart of another emergency call handling process performed by the mobile terminal during authentication of the base station in accordance with exemplary aspects of the disclosure;

FIG. 9 is an algorithmic flowchart of a further emergency call handling process performed by the mobile terminal during authentication of a base station in accordance with exemplary aspects of the disclosure; and

FIG. 10 is a schematic diagram of the circuitry of an exemplary mobile terminal and an exemplary base station in accordance with the disclosure.

### DETAILED DESCRIPTION OF THE PREFERRED EMBODIMENTS

In an exemplary aspect, a method that causes a mobile device to place an emergency call in a wireless cellular network includes receiving, in a processing circuit of the mobile device, initiation of an emergency call, and determining an authentication of a first base station corresponding to a first cell based on an authentication timer of the mobile device. The method also includes establishing a communication connection to a second base station corresponding to a second cell when the authentication timer indicates an authentication failure of the first base station, and placing the emergency call via the communication connection to the second base station.

In another exemplary aspect, a mobile apparatus that places an emergency call over a wireless cellular network includes an input circuit that receives initiation of the emergency call. The mobile apparatus also includes an authentication timer that establishes a time period for authentication of a first base station corresponding to a first cell, and a control circuit. The control circuit determines authentication of the first base station based on a state of the authentication timer circuit, where expiration of the authentication timer circuit indicates an authentication failure of the first base station. Upon receipt of the initiation of the emergency call by the input circuit and authentication failure of the first base station, the control circuit establishes a communication connection with the first base station, places the emergency call via the first base station, and bars the first base station upon completion of the emergency call.

In a further exemplary aspect, a system for placing an emergency call via a wireless cellular network includes a first base station that establishes a first wireless cell, and at least one second base station that establishes at least one second wireless cell. The system also includes a mobile terminal that includes an input circuit that receives initiation of an emergency call, an authentication timer circuit that establishes a time period for authentication of the first base station, and a control circuit. Upon receipt of the initiation of the emergency call by the input circuit, the control circuit places the emergency call via the first base station, but aborts the emergency call upon expiration of the authentication timer circuit, where expiration of the authentication timer circuit indicates an authentication failure of the first base station. The control circuit then establishes a communication connection with another base station, and places the emergency call via the communication connection with the other base station.

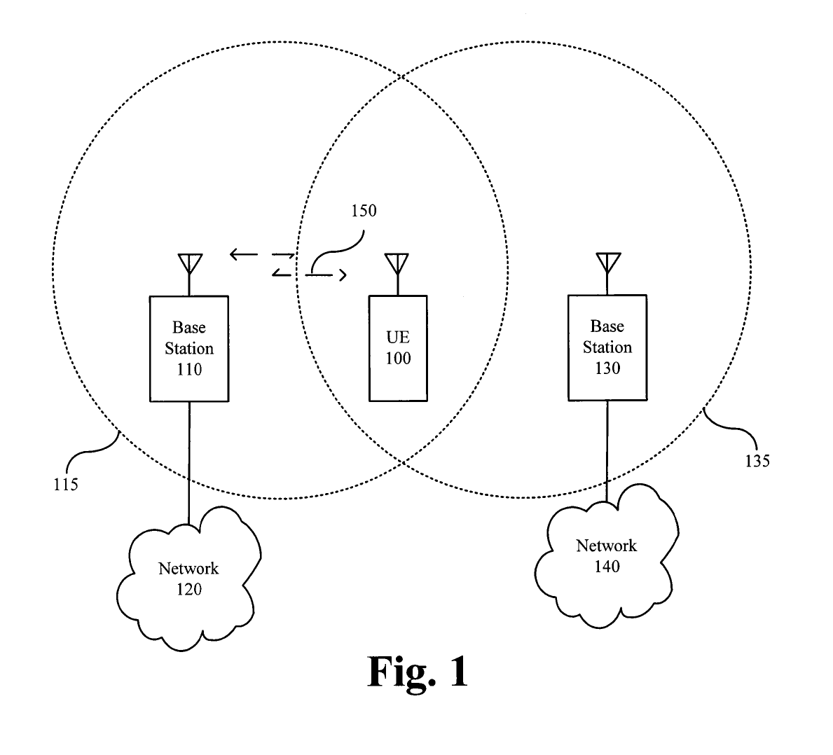

Referring now to the drawings, wherein like reference numerals designate identical or corresponding parts throughout the several views, FIG. 1 is a diagram of authentication between a mobile terminal, also referred to herein as user equipment 100, and a base station 110 that forms a first cell 115 of a wireless cellular network 120. Though the wireless cellular network 120 is illustrated as having only one cell 115 and one base station 110, the cellular network 120 may have any number of cells and base stations without departing from the scope of the present disclosure.

The wireless cellular network 120 may comply with a cellular communication standards, such as 3GPP, 3GPP LTE, 4G or 4G LTE. As part of these standards, the wireless cellular network 120 periodically instructs the user equipment 100 to perform an authentication process in order to authenticate the base station 110. As can be appreciated, authentication of the user equipment 100 by the base station 110 may also be performed upon instruction by the network 140. FIG. 1 illustrates the authentication exchange between the user equipment 100 and the base station 110 as the dashed line 150. Such authentication is periodically performed by the user equipment 100 at the behest of the wireless cellular network 120 to avoid connection to a “false” cell formed by an unauthenticated base station. As used herein the term “false cell” is a cell whose base station(s) have not be authenticated previously by the user equipment 100.

FIG. 1 also illustrates a second base station 130 connected to a second network 140. The second base station 130 establishes a second cell 135 in which the user equipment 100 also resides. However, the user equipment is not connected and therefore is not communicating with the base station 130 in FIG. 1.

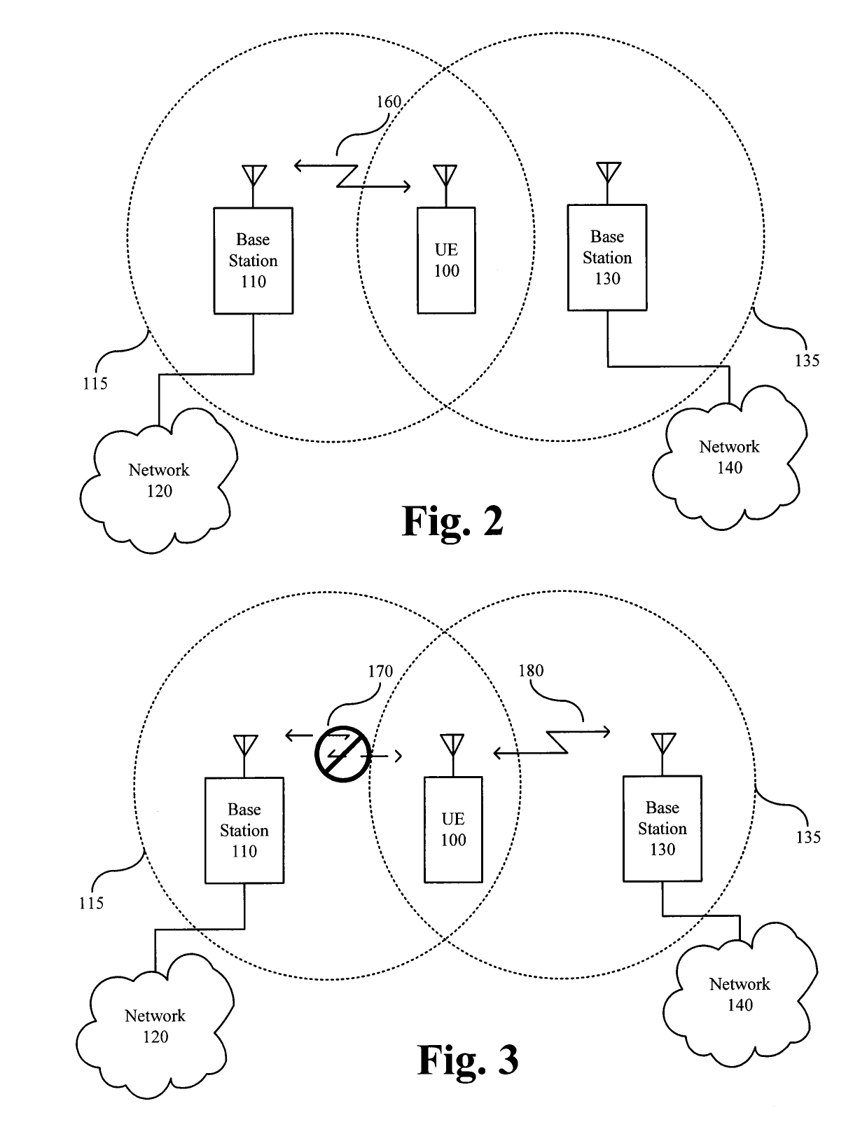

FIG. 2 illustrates the outcome of a successful authentication between the base station 110 and the user equipment 100. After the user equipment 100 successfully authenticates the base station 110, the user equipment 100 connects to the base station 110 as illustrated by solid line 160, and thereafter provides a user with services including voice calls, short message service (SMS), Internet access, e-mail access, and multimedia streaming. Other services are also possible without departing from the scope of this disclosure.

FIG. 3 illustrates an authentication failure between the user equipment 100 and the base station 110. When the user equipment 100 is unable to authenticate the base station 110 during a predetermined period of time, the user equipment 100 bars the base station 110 and does not communicate further with the base station 110, as illustrated by the reference numeral 170. Instead, the user equipment 100 establishes a communication connection to base station 130 of wireless cellular network 140 and provides SMS, Internet, e-mail and other services through this connection. Because authentication of a base station by the user equipment 100 is performed upon receipt of instructions from the wireless cellular network, connection of the user equipment 100 to the base station 130 does not necessarily require authentication of the base station 130 by the user equipment 100.

Base station 110 does not remain permanently barred, however. The user equipment 100 may again try to authenticate and communicate with base station 110 after a predetermined bar time-period elapses. The bar time-period may be set according to one of the communication standards described above, or may be set to any other value. In one exemplary aspect, the bar time-period may be set by a user of the user equipment through, for example, a settings menu. Also, the base station 110 may not be barred after an authentication failure if it is the only base station available to the user equipment 100.

FIGS. 1-3 illustrate base stations 110 and 130 as being connected to different wireless cellular networks 120, 140. However, the base stations 110 and 130 may be connected to the same wireless cellular network (i.e., wireless cellular networks 120 and 140 may be the same network or may be parts of the same network) or wireless cellular networks 120, 140 may communicate with each other. Although only two cells 115, 135 from two wireless networks 120, 140 are illustrated in FIGS. 1-3, many more cells from more than two networks are also possible. The base stations 110 and 130 may be connected to their respective wireless cellular networks 120, 140 via broadband, optical fiber or another wireless link, such as a satellite link. Thus, the specific structure and implementation of the wireless cellular networks may vary without departing from the scope of this disclosure.

An authentication failure of base station 110 may occur if, for example, a media access (MAC) address cannot be verified, if non-Evolved Packets System (EPS) authentication is not accepted, or if there is an SQN failure. If one or more of these issues occur, and the base station 110 and user equipment 100 cannot resolve the issue, the user equipment 100 bars the base station 110 and refuses connection. As noted above, the barring of the base station 110 is not permanent and the user equipment may retry authentication after a predetermined period of time elapses.

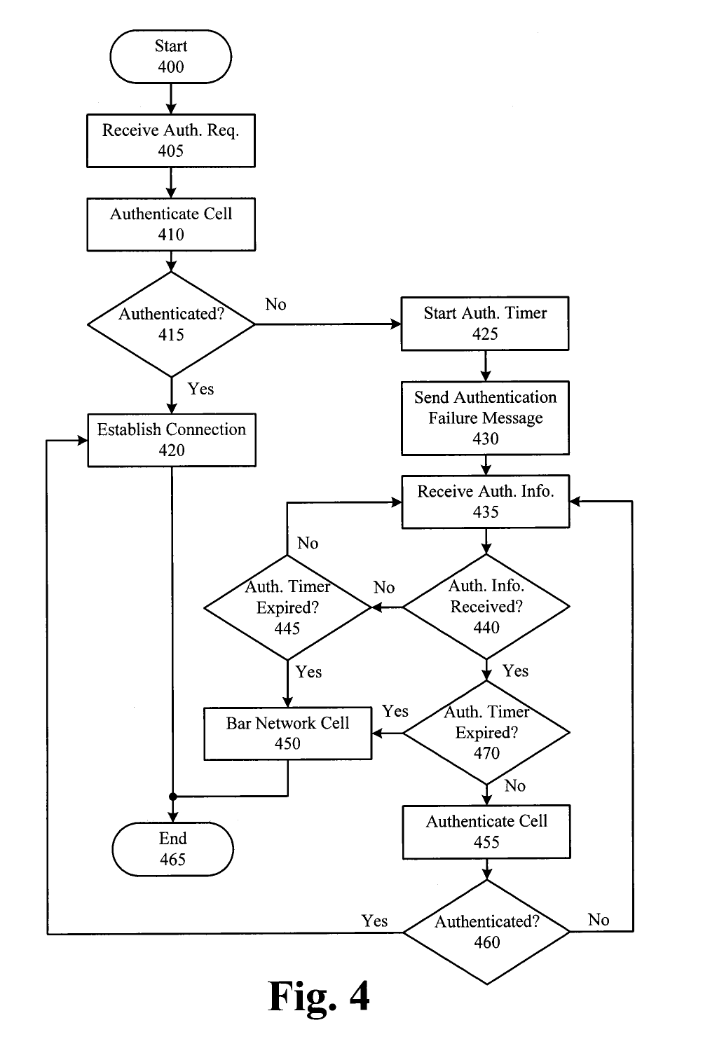

Next, an exemplary algorithmic process for authenticating a base station is described in greater detail with reference to FIG. 4. FIG. 4 is a flowchart that illustrates the algorithmic process for authenticating a base station by user equipment. For the sake of clarity and simplicity, the description of FIG. 4 is made using authentication between base station 110 and user equipment 110 as an example, base station 130 being used as a fallback if authentication of the base station 110 fails. However, the same description applies to authentication of any base station by any user equipment.

In FIG. 4, the process begins at step 400 and proceeds to step 405 in which the user equipment 100 receives an authentication request from a wireless cellular network, for example, wireless cellular network 120. After receiving the authentication request, the user equipment 100 attempts to authenticate the base station 110 at step 410. At step 415, the user equipment 100 determines whether the authentication is successful. If the authentication is successful, the user equipment 100 establishes a communication connection to the base station 110 at step 420, and the authentication process ends at step 465.

If at step 415, the user equipment 100 determines that the authentication of the base station 110 has failed, the user equipment 100 proceeds to step 425 in order to start an authentication timer. The authentication timer is set to expire after the lapse of a predetermined time period during which the base station 110 and the user equipment exchange further communications in an attempt to achieve a successful authentication. As noted above, the predetermined time period set by the authentication timer may be according to a communication standard or any other time period known to one of ordinary skill in the art, and may be fixed or variable under either user or network control.

After starting the authentication timer, the user equipment 100 sends an authentication failure message to the wireless cellular network 120 at step 430. The authentication failure message notifies the wireless cellular network 120 that authentication has failed and provides a reason for the failure, such as an incorrect MAC address, that non-EPS authentication was not accepted and/or that there is an SQN failure. At step 435, the user equipment 100 awaits a further response from the base station 110 in an effort to authenticate itself to the user equipment 100 prior to expiration of the authentication timer. At step 440 the user equipment 100 determines whether additional authentication information has been received. If no additional authentication information is received, the user equipment 100 proceeds to step 445 to determine whether the authentication timer has expired. If the authentication timer has not expired, the user equipment 100 returns to step 435 to await the additional authentication information. If the authentication timer has expired, the user equipment 100 proceeds from step 445 to step 450 in which the base station 110 is barred. Then the process ends at step 465.

Returning to step 440, if additional authentication information is received at step 440, the user equipment 400 determines whether the authentication timer has expired at step 470. If the authentication timer has expired, the user equipment 100 proceeds to step 450 and bars the base station 110. Otherwise, the user equipment proceeds to step 455 and again attempts to authenticate the network and base station 110. At step 460, the user equipment 100 determines whether authentication is successful. If it is, the user equipment 100 proceeds to step 420 in order to establish a communication connection with the base station 110, and the process ends at step 465. If, on the other hand, authentication is not successful at step 460, the user equipment reverts to step 435 in order to await further authentication information from the base station 110. This process continues until either the base station 110 is authenticated or the authentication timer expires and the base station 110 is barred.

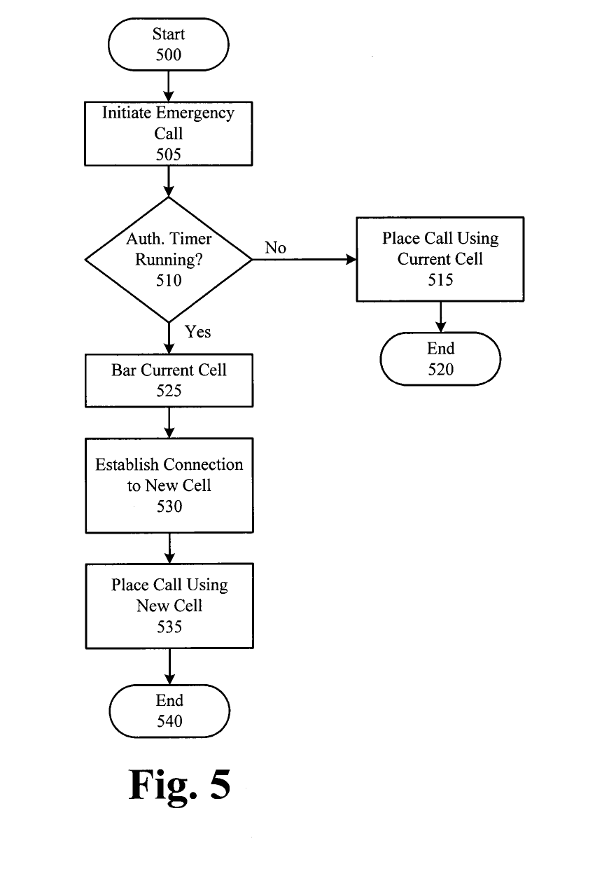

Next, the handling of an emergency call, which is a call requesting urgent assistance from, for example, police or fire rescue personnel is described with reference to FIG. 5. FIG. 5 is an algorithmic flow chart of emergency call handling by the user equipment 100 in accordance with exemplary aspects of the disclosure. In FIG. 5, it is assumed that the authentication process described above with reference to FIG. 4 is ongoing. The process in FIG. 5 begins at step 500 and proceeds to step 505 during which an emergency call is initiated. As can be appreciated, the emergency call may be initiated in a variety of ways. For example, the emergency call may be initiated by dialing a predetermined phone number on a keypad of the user equipment 100, or may be initiated by a voice command from the user of the user equipment 100. The emergency call may also be initiated through a predetermined keystroke pattern or upon determination by the user equipment 100 that certain conditions, such as user heart rate, sharp noise, alarm sounds and the like, have been satisfied.

Returning to FIG. 5, at step 510, the user equipment 100 determines whether the authentication timer is currently running. If the authentication timer is not running, then authentication of the base station 110 (also referred to as the “current base station”) is not being performed or has been recently completed and the base station 110 has been authenticated. Therefore, the user equipment 100 proceeds to step 515 in order to place the emergency call using the current cell, which corresponds to base station 110. The process then ends at step 520.

If, on the other hand, the authentication timer is determined to be running at step 510, the user equipment 100 proceeds to step 525 in order to immediately bar the base station 110. At step 530, the user equipment 100 establishes a connection to a new cell, for example cell 135 corresponding to base station 130. Once this connection is established, the user equipment 100 places the emergency call via the connection to base station 130 at step 535 and the process ends at step 540.

Because base station 110, is immediately barred by the user equipment 100, the user equipment 100 may either prematurely stop the authentication timer or may allow the authentication timer to expire on its own. As noted above, once base station 110 is barred, the user equipment 100 will not communicate with base station 110 until the bar time-period has elapsed. After the bar time-period elapses, however, the user equipment 100 is free to attempt authentication of the base station 110 again. Re-authentication of base station 110 by the user equipment 100 may be initiated under direction of the network 120 or 140, under user direction, or because the user equipment 100 is no longer within the coverage area of the base station 130, but is still within the coverage area of bases station 110. Other methods of initiating re-authentication of base station 110 after the elapse of the bar time-period are also possible as would be recognized by one of ordinary skill in the art.

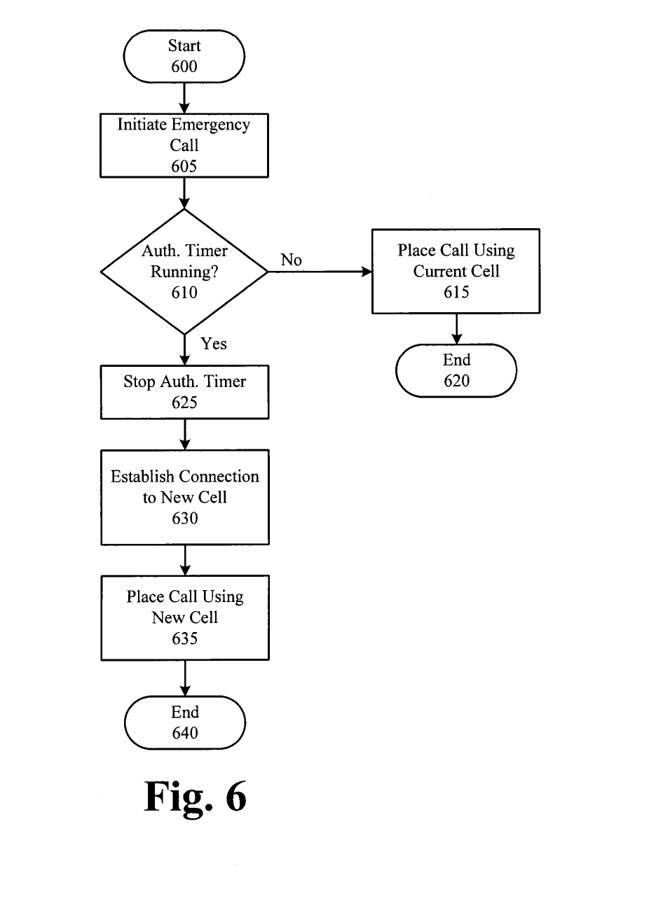

Next, another emergency call handling process according to exemplary aspects of the disclosure is described with reference to FIG. 6. The algorithmic process of FIG. 6 begins at step 600 and proceeds to step 605 during which the emergency call is initiated. Initiation of the emergency call may be made through any of the methods described above with reference to FIG. 5.

After the emergency call is initiated at step 605, the user equipment 100 determines whether the authentication timer is running at step 610. If the authentication timer is not running, the user equipment places the call via the base station 110. If, however, the user equipment 100 determines at step 610 that the authentication timer is running, the user equipment 100 proceeds to step 625 to stop the authentication timer. Then, at step 630 the user equipment 100 establishes a communication connection to the base station 130 (i.e., the base station of the “new” cell 135) and proceeds to step 635 in order to place the emergency call using the communication connection to base station 130. The process then ends at step 640.

Because in FIG. 6 the authentication timer is not allowed to expire, the base station 110 is not barred because of a failed authentication. Thus, the user equipment 100 is free to attempt to authenticate base station 110 immediately after the emergency call without having to wait for the bar time-period to elapse. Alternatively, the user equipment 100 may continue to use the communication connection to base station 130 to provide its user with communication services. Of course, if base station 110 is successfully authenticated during the emergency call, the user equipment 100 may reset the stopped authentication timer and leave the authentication timer deactivated (i.e., not running as in the case where authentication is not performed). Then the user equipment can continue using the base station 110.

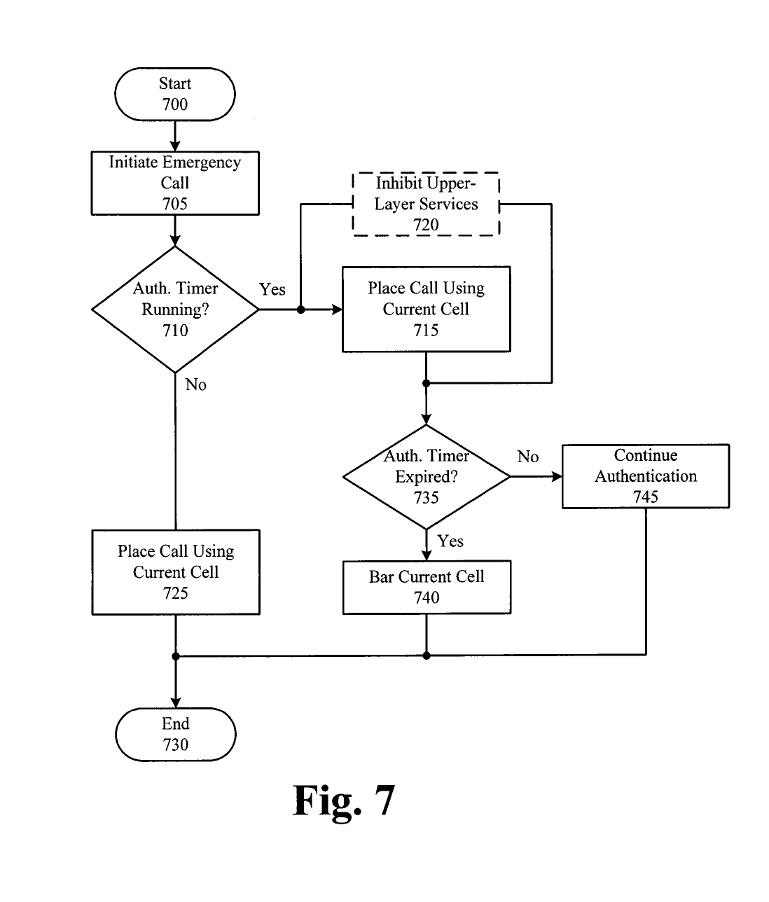

Next, a further emergency call handling method performed by the user equipment 100 is described with reference to FIG. 7. As with the above descriptions, FIG. 7 assumes that the authentication of base station 110 is underway. The algorithmic process of FIG. 7 begins at step 700 and proceeds to step 705 during which the emergency call is initiated as discussed above. At step 710, the user equipment 100 determines whether the authentication timer is running. If the authentication timer is not running, the user equipment 100 proceeds to step 725 in order to place the emergency call through base station 110, and the process ends at step 730.

If at step 710 the user equipment 100 determines that the authentication timer is running, the user equipment 100 proceeds to step 715 in order to place the emergency call via the base station 110 even though this base station has not been authenticated or has failed authentication. After the emergency call is complete, the user equipment 100 proceeds to step 735 to determine whether the authentication timer has expired. If the authentication timer has not expired, the user equipment 100 proceeds to step 745 in order to continue with the authentication process that was described previously with reference to FIG. 4. The process then ends at step 730.

If at step 735, the user equipment 100 determines that the timer has expired, the user equipment proceeds to step 740 in order to bar base station 110, and the process ends at step 730. In this way, the algorithmic process illustrated in FIG. 7 allows the emergency call to go forward even if the base station 110 has not yet been authenticated. This allows the emergency call to be placed when there is only one base station 110 and that base station fails authentication. After the emergency call is placed, the base station 110 may be barred as discussed above.

Because the user equipment 100 places the emergency call at step 715 through a base station 110 that has not been authenticated or has failed authentication, the user equipment 100 may also inhibit provision of additional services, such as SMS, Internet, and e-mail through bases station 110 at step 720. As illustrated in FIG. 7, step 720 and step 715 may be performed in parallel. Of course, steps 720 and 715 may also be performed sequentially with either step being first, or may be performed in any other order.

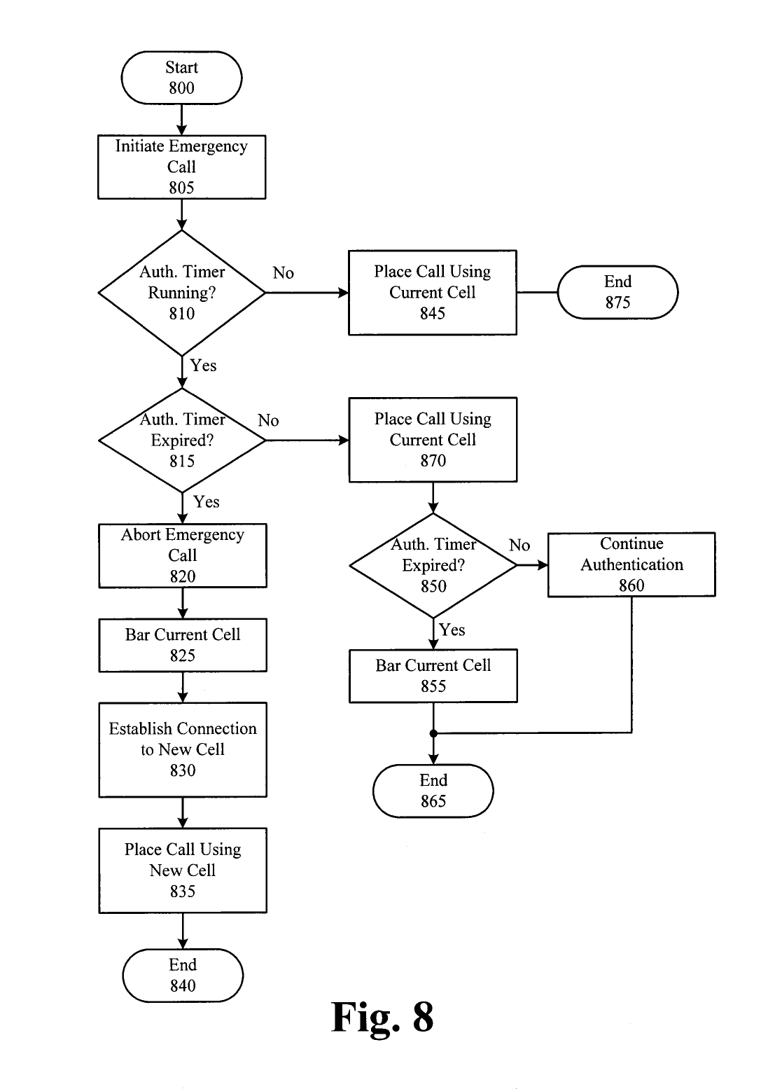

FIG. 8 is an algorithmic process for handling an emergency call according to further exemplary aspects of the disclosure. The algorithmic process begins at step 800 and proceeds to step 805 during which the emergency call is initiated as discussed above. At step 810, the user equipment 100 determines whether the authentication timer is running. If the authentication timers not running, the user equipment 100 proceeds to step 845 in which the user equipment 100 places the emergency call through the base station 110. The process then ends at steps 875.

If at step 810 the user equipment 100 determines that the authentication timer is running, it proceeds to step 815 to determine whether the authentication timer has expired. If the authentication timer has not expired, the user equipment proceeds to step 870 to place the emergency call using the base station 110 though this base station is not authenticated. After the emergency call is complete, the user equipment 100 determines whether the timer has expired at step 850, and bars the base station 110 at step 855 if the authentication timer has expired. Then the process ends at step 865. Because the user equipment 100 places the call at step 870 through an unauthenticated base station, base station 110, the user equipment 100 may also inhibit higher level services, such as SMS, Internet and e-mail during this step.

If at step 850, the user equipment 100 determines that the authentication timer has not expired, the user equipment 100 continues with the authentication process described with reference to FIG. 4 at step 860, and the process ends at step 865.

Returning to step 815, if during this step the user equipment 100 determines that the authentication timer has expired, the user equipment proceeds to step 820 in order to abort the emergency call. In other words, the user equipment 100 does not establish the call, or interrupts the call if it is ongoing. Then, the user equipment 100 proceeds to step 825 in order to bar the base station 110. Then, the user equipment 100 establishes a connection with a base station 130 at step 830, and places the emergency call using the connection to base station 130 at step 835. The process ends at step 840.

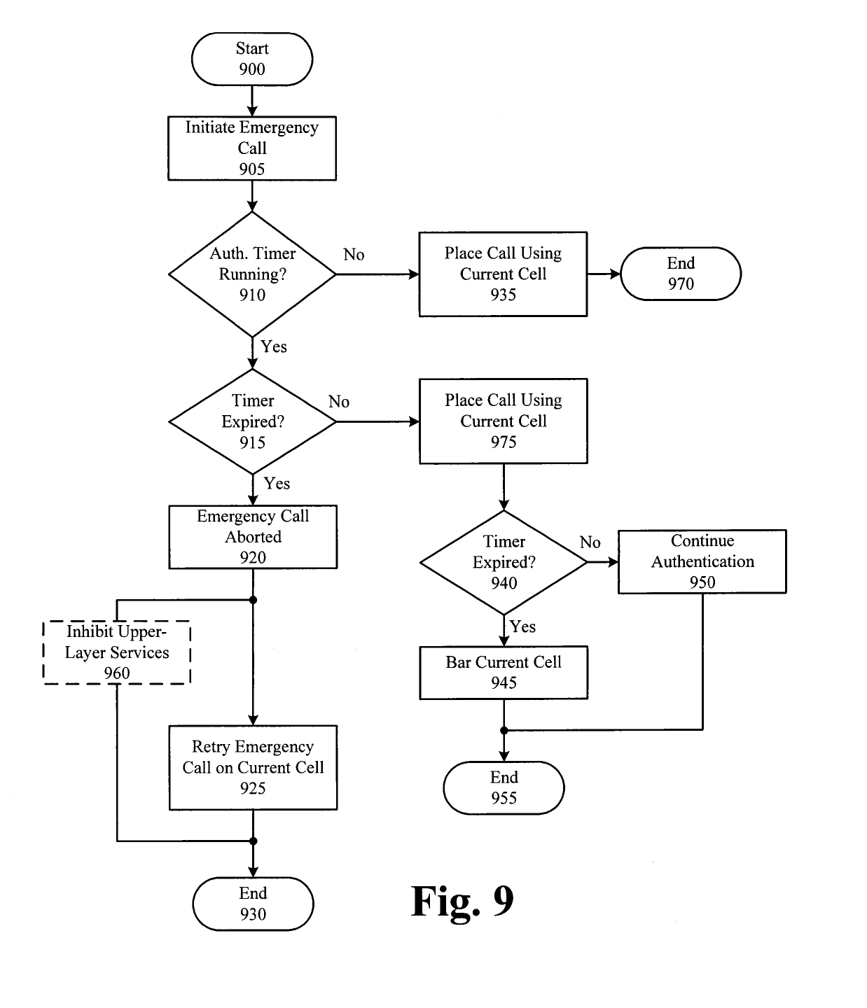

Next, another algorithmic emergency call handling method in accordance with aspects of the disclosure is described with reference to FIG. 9. In FIG. 9, the process begins at step 900 and proceeds to step 905 during which the emergency call is initiated as described above. At step 910, the user equipment 100 determines whether the authentication timer is running. If the authentication timer is not running, the user equipment 100 places the emergency call using the base station 110 at step 935 and the process ends at step 970.

If at step 910, the user equipment 100 determines that the authentication timer is running, the user equipment 100 proceeds to step 915 to determine whether the authentication timer has expired. If the authentication timer has not expired, the user equipment 100 places the emergency call using the base station 110 at step 975 though this base station has not been authenticated. After the emergency call is placed, the user equipment 100 again determines whether the authentication timer has expired at step 940, and continues authentication at step 950 if the authentication timer has not expired. If at step 940 it is determined that the authentication timer has expired, the user equipment 100 bars base station 110 at step 945, and the process ends at step 955.

Returning to step 915, if the user equipment 100 determines that the timer has expired, the user equipment aborts the emergency call at step 920 since the authentication has failed. However, the user equipment 100 immediately retries the emergency call via base station 110 at step 925, though authentication failed. In other words, the base station 110 is not barred simply because authentication failed, but instead is used to place emergency call. Since authentication of base station 110 fails, the user equipment 100 may also inhibit upper layer services, such as SMS, Internet and e-mail step 960, which may be performed in parallel to step 925, or sequentially thereto. The process then ends at step 930.

One difference between the methods of FIGS. 8 and 9 is the base station used after the emergency call is aborted at step 825 of FIG. 8 or step 920 of FIG. 9. In FIG. 8 a connection to another base station is established while in FIG. 9 the emergency call is placed using the same base station that failed authentication. Which base station to use after the emergency call is aborted in FIGS. 8 and 9 may be made selectable based on user input, such as through a settings menu or through instructions received from the wireless cellular network 120 or 140. The user equipment may also determine which base station to use based on base station availability. For example, if more than one base station is available the user equipment 100 may chose a different base station from the one that failed authentication. However, if there is no other base station available, the user equipment may resort to placing the emergency call through the base station that failed authentication.

In certain exemplary aspects of the disclosure the emergency call handling methods described with reference to FIGS. 5-9 may be implemented as a set of computer-readable instructions in the memory of the user equipment 100. Selection of one of the methods may then be performed by the user through a settings menu or by the wireless network 120 or 140. Alternatively, the computer-readable instructions encoded in the memory of the user equipment 100 may include only one of the inventive methods of FIGS. 5-9, making user or network selection of an emergency call handling method unnecessary.

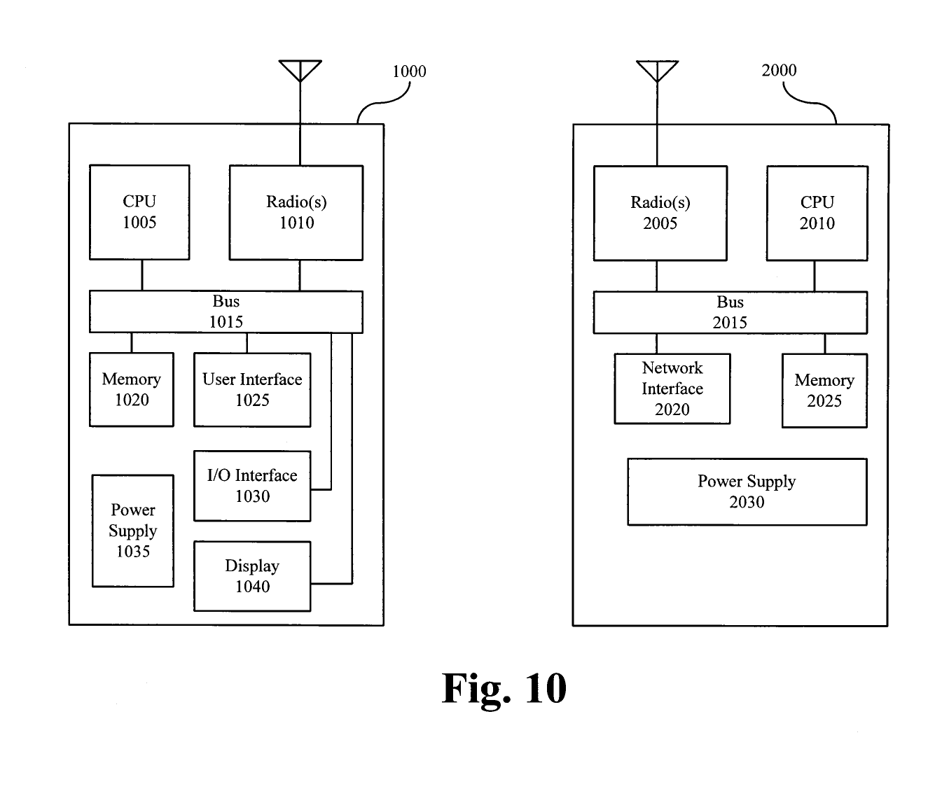

Next, FIG. 10 is a schematic diagram of the various circuits in an exemplary user equipment 1000 and an exemplary base station. As can be appreciated, user equipment 1000 may be a cellular phone, laptop computer or tablet computer that includes a radio or radios 1010 in order to communicate over a cellular network using, for example, GSM or CDMA transmission. The user equipment 1000 may also include a user interface 1025, which can be a keyboard, control buttons, control knobs, sliders or a combination thereof through which a user of the user equipment 1000 may make inputs. The user interface 1025 may also include a microphone to receive voice input and a speaker to provide audible feedback to a user.

The user equipment 1000 may also include a display 1040 to provide visual feedback to the user. The display 1040 may be an LCD display, LED display or any other known display. The display 1040 may also have a touch panel (not shown) arranged thereon to receive touch input from the user. Such touch panel maybe resistive, capacitive or a combination thereof, and may also form part of the user interface 1025.

An input/output interface 1030 may also be included in the user equipment 1000 in order to interface with other devices. Such an interface may include a connector, for example a universal serial bus (USB) connector, to connect the user equipment 1000 to, for example, a computer. The input/output interface 1030 may also include a wireless interfaces, such as a Wi-Fi interface, Bluetooth interface, or near field communication (NFC) interface to communicate with other electronic devices as can be appreciated by one of ordinary skill in the art. The user equipment 1000 also include a power supply 1035 which may include a battery and associated charging circuits, as one of ordinary skill in the art would recognize.

Memory 1020 can be any combination of Read Only Memory (ROM), Random Access Memory (RAM), and FLASH memory which stores user data, computer-readable instructions that implement any of the above-described exemplary methods, and network settings. At least a subset of memory 1020 may also removable.

A central processing unit 1005 controls the overall operation and functionality of the user equipment 1000 through execution of the instructions stored in the memory 1020, and is interconnected with all of the above-described circuits via a bus 1015. The central processing unit may be a microprocessor circuit, such as an ARM processor or may be formed of discrete logic circuits. The central processing unit 1005 may also be a customized processor circuit implemented in an application specific integrated circuit (ASIC), a field programmable gate array (FPGA), or complex logic device (CPLD). The central processing unit 1005 may also include the authentication timer as part of its circuitry, or the timer circuit may be implemented as a stand-alone circuit using, for example, a crystal oscillator circuit or a real-time clock circuit.

Turning to the base station 2000, the base station 2000 also includes a central processing unit 2010, which can be an ARM processor, a microcontroller, and FPGA, a CPLD, or an ASIC that is interconnected to the other components of the base station 2000 via bus 2015. The base station 2000 also includes a radio or radios 2005 to communicate with user equipment, such as user equipment 1000 using any of the communication protocol standards described above. The base station 2000 also includes memory 2025, which can include ROM, RAM, FLASH or other memory types. Memory 2025 may be expandable or removable. The memory 2025 of base station 2000 includes the computer-readable instructions that when executed by the central processing unit 2010 cause the base station 2000 to perform the functions described above.

A network interface 2020 is also provided in the base station 2000 in order to interface to a larger network, such as wireless cellular network 120, as well as to allow for an interface through which to perform diagnostics on the base station 2000. As such, the network interface 2020 may include a wired interface such as a broadband interface or an optical interface, an Ethernet interface, or a USB interface. Of course, the network interface to 20 may also include wireless interfaces such as Bluetooth and Wi-Fi. The power supply 2030 provides power to the various circuits of the base station 2000 and may be hardwired to a power source. The power supply 2030 may also include a battery backup and associated charging and battery management circuitry.

The above descriptions include descriptions of algorithmic flowcharts illustrating process steps. These flow charts are exemplary and the process steps depicted therein may be performed in an order different from the order depicted in these figures. For example, the process steps may be performed in sequential, parallel or reverse order without departing from the scope of the present advancements. Also, the above descriptions have been organized as separate embodiments for ease of understanding of the inventive concepts described therein. However, one of ordinary skill in the art would recognize that the features of one embodiment may be combined with those of another without departing from the scope of the disclosure. Thus, the particular combination of features described in each of the embodiments is merely exemplary and the features described herein may be combined without limitation to form additional embodiments without departing from the scope of the present advancements.

Obviously, numerous modifications and variations of the present invention are also possible in light of the above teachings. It is therefore to be understood that within the scope of the appended claims, the invention may be practiced otherwise than as specifically described herein.

1. A method for causing a mobile apparatus to place an emergency call in a wireless cellular network, comprising:
receiving, in a processing circuit of the mobile apparatus, initiation of the emergency call;
determining an authentication of a first base station corresponding to a first cell based on an authentication timer of the mobile apparatus;
establishing a communication connection to a second base station corresponding to a second cell when the authentication timer indicates an authentication failure of the first base station; and
placing the emergency call via the communication connection to the second base station.

2. The method according to claim 1, wherein expiration of the authentication timer indicates the authentication failure of the first base station.

3. The method according to claim 2, further comprising barring the first base station upon expiration of the authentication timer.

4. The method according to claim 3, further comprising attempting authentication of the first base station after an elapse of a predetermined bar time period.

5. The method according to claim 1, further comprising:
stopping the authentication timer upon receipt of the initiation of the emergency call; and
attempting authentication of the first base station upon completion of the emergency call via the communication connection to the second base station.

6. The method according to claim 1 further comprising placing the emergency call via a communication connection to the first base station when the first base station is authenticated prior to expiration of the authentication timer.

7. A non-transitory computer-readable medium encoded with computer-readable instructions thereon that, when executed by a processing circuit, cause the processing circuit to perform the method according to claim 1.

8. A mobile apparatus that places an emergency call via a wireless cellular network, comprising:
an input circuit configured to receive initiation of the emergency call;
an authentication timer circuit configured to establish a time period for authentication of a first base station corresponding to a first cell; and
a control circuit configured to
determine authentication of the first base station based on a state of the authentication timer circuit, expiration of the authentication timer circuit indicating an authentication failure of the first base station, and
upon receipt of the initiation of the emergency call by the input circuit and authentication failure of the first base station,
establish a communication connection with the first base station,
place the emergency call via the communication connection with first base station, and
bar the first base station upon completion of the emergency call.

9. The mobile apparatus according to claim 7, wherein upon the receipt of the initiation of the emergency call and authentication failure of the first bases station, the control circuit is further configured to inhibit services other than the emergency call via the communication connection with first base station.

10. The mobile apparatus according to claim 8, wherein the services other than the emergency call include short messages service (SMS), Internet access and email access.

11. The mobile apparatus according to claim 7, wherein the control circuit is further configured to establish a communication connection with a second base station corresponding to a second cell after barring the first base station.

12. The mobile apparatus according to claim 7, wherein the control circuit does not bar the first base station when the first base station is authenticated prior to expiration of the authentication timer.

13. A system for placing an emergency call via a wireless cellular network, comprising:
a first base station configured to establish a first wireless cell;
at least one second base station configured to establish at least one second wireless cell; and
a mobile terminal that includes
an input circuit configured to receive initiation of the emergency call,
an authentication timer circuit configured to establish a time period for authentication of the first base station, and
a control circuit that upon receipt of the initiation of the emergency call by the input circuit is configured to
place the emergency call via the first base station,
abort the emergency call upon expiration of the authentication timer circuit, expiration of the authentication timer circuit indicating an authentication failure of the first base station,
establish a communication connection with another base station, and
place the emergency call via the communication connection with the other base station.

14. The system according to claim 13, wherein the other base station includes one of the first base station and the at least one second base station.

15. The system according to claim 14, wherein selection of the other base station as one of the first base station and the at least one second base station is determined based on a selection setting.

16. The system according to claim 15, wherein the selection setting is determined by the control circuit of the mobile terminal based on an availability of the at least one second base station.

17. The system according to claim 16, wherein the control circuit sets the selection setting to identify the first base station as the other base station when the at least one second base station is not available.

18. The system according to claim 15, wherein the selection setting is received by the input circuit of the mobile terminal from one of the wireless cellular network and a user of the mobile terminal.

19. The system according to claim 14, wherein when the other base station is the at least one second base station, the control circuit of the mobile terminal is further configured to bar the first base station.

20. The system according to claim 13, wherein when the other base station is the first base station, the control circuit of the mobile terminal is further configured to:
inhibit communication services other than the emergency call, and
attempt authentication of the first base station upon completion of the emergency call.
